(19) United States
(12) Patent Application Publication
(10) Pub. No.: US 2010/0026745 A1
(43) Pub. Date: Feb. 4, 2010

(54) LIQUID EJECTING APPARATUS

(75) Inventor: Naoki Kayahara, Chino-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Tokyo (JP)

(21) Appl. No.: 12/535,619

(22) Filed: Aug. 4, 2009

(30) Foreign Application Priority Data
Aug. 4, 2008 (JP) 2008-201101

(51) Int. Cl. B41J 29/38

(52) U.S. Cl. 347/10

(57) ABSTRACT

A liquid ejecting apparatus includes a head including: a first nozzle column where nozzles ejecting a first liquid are aligned in a predetermined direction at a predetermined interval; a second nozzle column where nozzles ejecting the first liquid are aligned in the predetermined direction at the predetermined interval; a third nozzle column where nozzles ejecting a second liquid are aligned in the predetermined direction at the predetermined interval; and a fourth nozzle column where nozzles ejecting the second liquid are aligned in the predetermined direction at the predetermined interval, wherein the first nozzle column is disposed off of the second nozzle column in a direction intersecting the predetermined direction, and the interval between a nozzle at an end portion of the first nozzle column and a nozzle at an end portion of the second nozzle column is the predetermined interval in the predetermined direction, wherein the fourth nozzle column is disposed off the third nozzle column in the direction intersecting the predetermined direction, and the interval between a nozzle at an end portion of the third nozzle column and a nozzle at an end portion of the fourth nozzle column is the predetermined interval in the predetermined direction, wherein the second nozzle column and the third nozzle column are disposed to be aligned in the predetermined direction, and wherein the liquids are ejected from the second nozzle column and the third nozzle column according to a common driving signal.

### BACKGROUND

1. Technical Field

The present invention relates to a liquid ejecting apparatus.

2. Related Art

As a liquid ejecting apparatus, an ink jet printer is known. The ink jet printer drives driving devices based on driving signals to perform printing by ejecting ink from nozzles corresponding to the driving devices. In addition, in a printer that performs printing by using a head having a plurality of nozzle columns, in order to suppress the misalignment of dot forming positions or variation in the ejection characteristics of each nozzle column, driving signal generators (waveform generating devices) are provided to the corresponding nozzle columns (for example, refer to Patent Document JP-A-10-291310).

However, in a printer such as the one disclosed in Patent Document JP-A-10-291310, where the driving signal generators are provided to the corresponding nozzle columns, if the head has a large number of nozzle columns, a large number of driving signal generators are also needed. Therefore, cost is increased.

### SUMMARY

An advantage of some aspects of the invention is that it is possible to reduce cost.

According to an aspect of the invention, there is provided a liquid ejecting apparatus that includes a head including: a first nozzle column where nozzles ejecting a first liquid are aligned in a predetermined direction at a predetermined interval; a second nozzle column where nozzles ejecting the first liquid are aligned in the predetermined direction at the predetermined interval; a third nozzle column where nozzles ejecting a second liquid are aligned in the predetermined direction at the predetermined interval; and a fourth nozzle column where nozzles ejecting the second liquid are aligned in the predetermined direction at the predetermined interval. The first nozzle column is disposed off of the second nozzle column in a direction intersecting the predetermined direction, and the interval between a nozzle at an end portion of the first nozzle column and a nozzle at an end portion of the second nozzle column is the predetermined interval in the predetermined direction. The fourth nozzle column is disposed off of the third nozzle column in the direction intersecting the predetermined direction, and the interval between a nozzle at an end portion of the third nozzle column and a nozzle at an end portion of the fourth nozzle column is the predetermined interval in the predetermined direction. The second nozzle column and the third nozzle column are disposed to be aligned in the predetermined direction, and the liquids are ejected from the second nozzle column and the third nozzle column according to a common driving signal.

Other features of the invention will be clarified by the specification and the accompanying drawings.

### BRIEF DESCRIPTION OF THE DRAWINGS

The invention will be described with reference to the accompanying drawings, wherein like numbers reference like elements.

FIG. 1 is a block diagram showing a whole construction of a printer.

FIG. 2A is a cross-sectional view showing a printer, and FIG. 2B is a view showing a state in which a sheet is transported.

FIG. 3A is a view showing an array of heads, and FIG. 3B is a view showing an array of nozzles in a joint portion of the heads.

FIG. 4 is an electronic circuit view showing the operations of a driving device.

FIG. 5 is a timing chart showing timings of signals.

FIG. 6A is a view showing a driving signal generator, and FIG. 6B is a view showing a waveform generating circuit.

FIG. 7 is a view showing dot positions formed by simultaneously ejecting liquids from a main nozzle group and a sub nozzle group.

FIG. 8 is a view showing the difference between a driving signal of a main nozzle group and a driving signal of a sub nozzle group.

FIG. 9 is a schematic view showing a head driving circuit according to a comparative example.

FIG. 10 is a view showing dot positions formed by simultaneously ejecting liquids from eight nozzle columns.

FIG. 11 is a schematic view showing a head driving circuit according to an embodiment.

FIG. 12 is a schematic view showing a head driving circuit according to a circuit example 2.

FIG. 13 is a schematic view showing a head driving circuit according to a modified example.

### DESCRIPTION OF EXEMPLARY EMBODIMENTS

The following description will be clarified by the specification and the accompanying drawings.

There is realized a liquid ejecting apparatus that includes a head including: a first nozzle column where nozzles ejecting a first liquid are aligned in a predetermined direction at a predetermined interval; a second nozzle column where nozzles ejecting the first liquid are aligned in the predetermined direction at the predetermined interval; a third nozzle column where nozzles ejecting a second liquid are aligned in the predetermined direction at the predetermined interval; and a fourth nozzle column where nozzles ejecting the second liquid are aligned in the predetermined direction at the predetermined interval. The first nozzle column is disposed off of the second nozzle column in a direction intersecting the predetermined direction, and the interval between a nozzle at an end portion of the first nozzle column and a nozzle at an end portion of the second nozzle column is the predetermined interval in the predetermined direction. The fourth nozzle column is disposed off of the third nozzle column in the direction intersecting the predetermined direction, and the interval between a nozzle at an end portion of the third nozzle column and a nozzle at an end portion of the fourth nozzle column is the predetermined interval in the predetermined direction. The second nozzle column and the third nozzle column are disposed to be aligned in the predetermined direction, and the liquids are ejected from the second nozzle column and the third nozzle column according to a common driving signal.

According to the liquid ejecting apparatus, since the liquids are ejected from the second nozzle column and the third nozzle column according to the common driving signal, in comparison with a case where the liquids are ejected from the second nozzle column and the third nozzle column according to other driving signals, it is possible to decrease the number of driving signal generators that generate the driving signals and to reduce cost. In addition, it is possible to prevent circuits from becoming complicated.

In the liquid ejecting apparatus, a first driving signal generating unit generates a driving signal that is used to eject the first liquid from the first nozzle column, a second driving signal generating unit generates the common driving signal, and a third driving signal generating unit generates a driving signal that is used to eject the second liquid from the fourth nozzle column.

According to the liquid ejecting apparatus, it is possible to equalize the intersecting-direction positions of the dot columns formed by the nozzle columns that are disposed off of each other in the direction intersecting the predetermined direction and to suppress deterioration in image quality.

In the liquid ejecting apparatus, the number of nozzles of the second nozzle column is smaller than that of the first nozzle column, and the number of nozzles of the fourth nozzle column is smaller than that of the third nozzle column.

According to the liquid ejecting apparatus, in a case where the head is aligned in a predetermined direction, it is possible to align the nozzles in the predetermined direction at equal intervals.

In the liquid ejecting apparatus, a plurality of the heads are disposed to be aligned in the predetermined direction, and the second liquids are ejected from the fourth nozzle columns of the heads according to the driving signal generated by the third driving signal generating unit.

According to the liquid ejecting apparatus, it is possible to decrease the number of driving signal generators and to reduce cost.

In the liquid ejecting apparatus, a generating timing of a driving pulse included in the driving signal generated by the first driving signal generating unit, a generating timing of a driving pulse included in the driving signal generated by the second driving signal generating unit, and a generating timing of a driving pulse included in the driving signal generated by the third driving signal generating unit are adjusted.

According to the liquid ejecting apparatus, it is possible to adjust the liquid ejecting timings of the nozzle columns that are shifted in the direction intersecting the predetermined direction. As a result, it is possible to equalize the intersecting-direction positions of the dot columns formed by the nozzle columns and to suppress deterioration in image quality.

In the liquid ejecting apparatus, the head includes: a first input unit to which a driving signal that is used to eject the first liquid from the nozzles of the first nozzle column is input; a second input unit to which the common driving signal is input; and a third input unit to which a driving signal that is used to eject the second liquid from the nozzles of the fourth nozzle column is input.

According to the liquid ejecting apparatus, since the driving signals that are used to eject the liquids from the nozzle columns that are shifted in the direction intersecting the predetermined direction can be individually adjusted, it is possible to equalize the intersecting-direction positions of the dot columns formed by the nozzle columns and to suppress deterioration in image quality.

### Line Head Printer

In an embodiment, a line head printer among ink jet type printers will be described as an example of a liquid ejecting apparatus. Firstly, the line head printer (hereinafter, referred to as a printer 1) will be described.

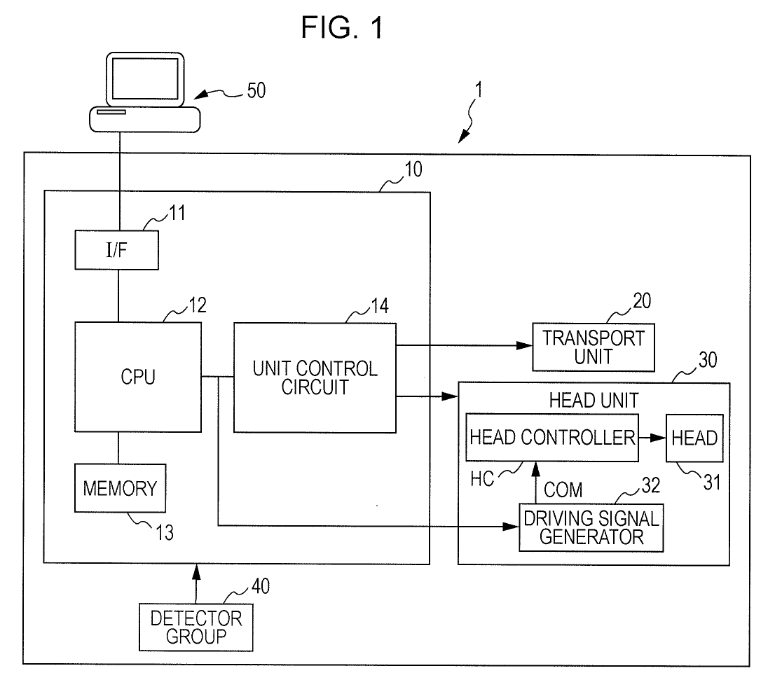

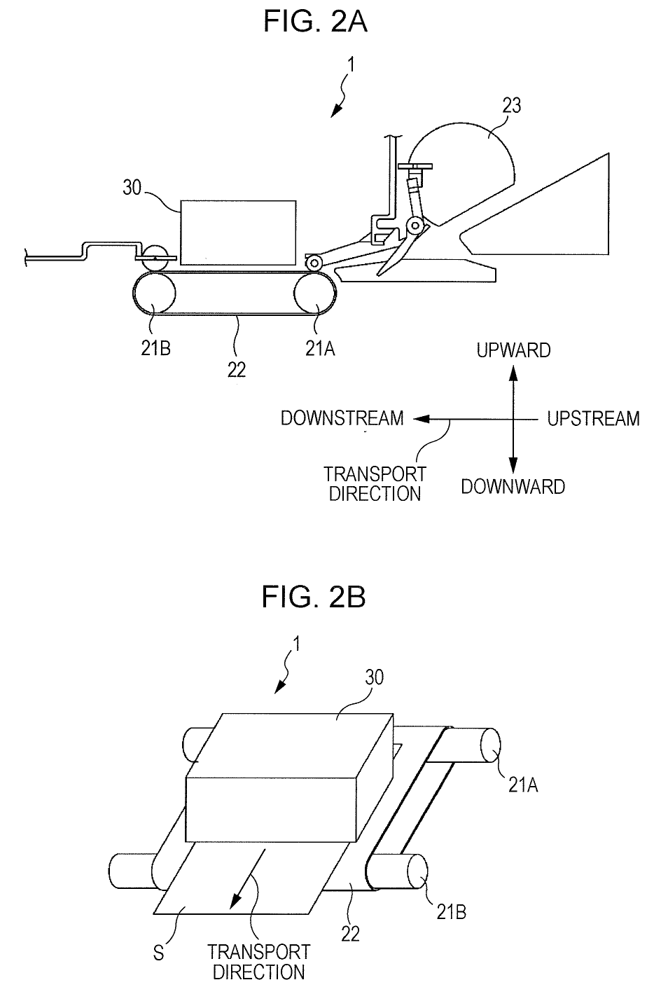

FIG. 1 is a block diagram showing a whole construction of a printer 1. FIG. 2A is a cross-sectional view showing the printer 1. FIG. 2B is a view showing a state in which a sheet (medium) S is transported in the printer 1. When receiving printing data from a computer 50 as an external apparatus, the printer 1 uses a controller 10 to control each unit (transport unit 20, head unit 30) so as to form an image on the sheet S. In addition, a detector group 40 detects states of the printer 1. The controller 10 controls each unit based on the result of the detection. The detector group 40 includes, for example, sensors detecting the sheet S at the time of feeding, rotary encoders that are used to transport only a predetermined transport amount of sheets S, or the like.

The controller 10 is a control unit for controlling the printer 1. An interface unit 11 is provided to perform data transmission and reception between the printer 1 and the computer 50 as an external apparatus. A CPU 12 is an arithmetic processing unit for controlling the whole of the printer 1. A memory 13 is a device for ensuring a program storing region or an execution region for the CPU 12. The CPU 12 uses a unit control circuit 14 to control each unit according to programs stored in the memory 13.

The transport unit 20 sends the sheet S to a printable position and, at the time of printing, transports the sheet S by a predetermined transport amount in the transport direction (corresponding to an intersecting direction). A feed roller 23 is a roller for automatically feeding the sheet S inserted through a paper insert opening onto a transport belt 22 in the printer 1. Next, the ring-shaped transport belt 22 is rotated by transport rollers 21A and 21B, so that the sheet S on the transport belt 22 can be transported. The sheet S is attached on the transport belt 22 by electrostatic adsorption or vacuum adsorption.

The head unit 30 is a unit for ejecting the ink on the sheet S. The head unit 30 includes a plurality of heads 31 that are aligned in the transport direction. Each head 31 (tip) is provided with a plurality of nozzles as an ink ejector. Each nozzle is provided with a pressure chamber in which an ink (liquid) is contained and a driving device (piezo device) for ejecting the ink by changing a volume of the pressure chamber. When the pressure chamber is expanded and contracted by applying voltages (driving pulses) to the driving device, the ink can be ejected from the nozzle. In addition, not limited thereto, a heating device (corresponding to the driving device) may be provided to an inner portion of the pressure chamber. In this case, heat is generated by applying voltages (driving pulses) to the heating device, so that bubbles can be generated in the pressure chamber by the heat. As a result, the liquid can be ejected from the nozzle by the generated bubbles.

In the printer 1, firstly, the controller 10 that receives the printing data rotates the feed roller 23 to send the to-be-printed sheet S onto the transport belt 22. Next, the sheet S is transported on the transport belt 22 at a constant speed without stoppage, so that the sheet S can be transported under the head unit 30. While the sheet S is transported under the head unit 30, the ink is intermittently ejected from each nozzle. As a result, dot columns including a plurality of dots are formed on the sheet S along the transport direction, so that an image can be printed.

### Array of Nozzles

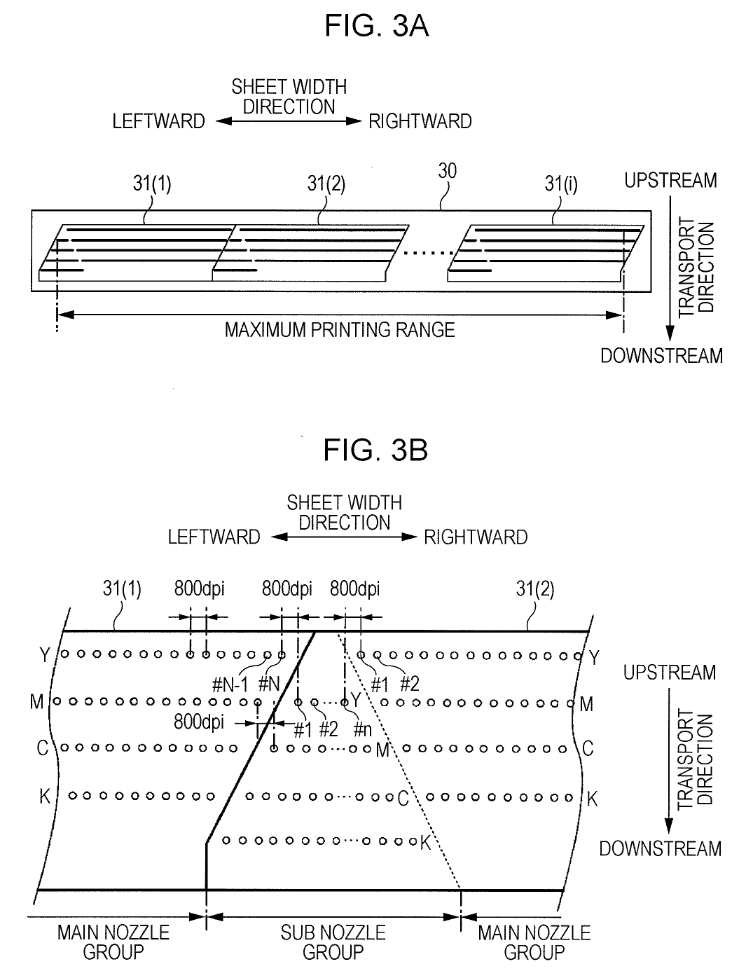

FIG. 3A is a view showing an array of heads 31 on a bottom surface of the head unit 30. FIG. 3B is a view showing an array of nozzles in ajoint portion of the head 31. In the line head printer where the nozzles are aligned at a predetermined interval to extend across the length of a sheet, high speed printing can be performed. However, due to manufacturing problems (yield ratio or the like), it is difficult to dispose nozzle columns to extend across the length of a sheet in one head. For this reason, in the embodiment, as shown in FIG. 3A, a plurality of short heads 31 are disposed to be aligned in the sheet width direction (corresponding to the predetermined direction) on the bottom surface of the head unit 30. For the description, reference numerals are given in an ascending order from the left head 31 in the sheet width direction.

As shown in FIG. 3B, the nozzles included in each head 31 are classified into a main nozzle group and a sub nozzle group. The number of nozzles of the sub nozzle group is smaller than that of the main nozzle group. The sub nozzle group is disposed at the left end portion of the head 31 in the sheet width direction, and the main nozzle group is distributed from the right side of the sub nozzle group to the right end portion of the head 31. In addition, each of the main nozzle group and sub nozzle group is provided with a yellow nozzle column Y, a magenta nozzle column M, a cyan nozzle column C, and a black nozzle column K. In addition, the nozzle columns of the sub nozzle group are shifted by one column from the nozzle columns of the main nozzle group toward the downstream of the transport direction. In other words, the nozzle columns of the sub nozzle group are disposed off of the nozzle columns of the main nozzle group in the direction of the transport

For this reason, in the same head 31, the yellow nozzle column Y of the sub nozzle group and the magenta nozzle column M of the main nozzle group are aligned with each other in the sheet width direction. Similarly, the magenta nozzle column M of the sub nozzle group and the cyan nozzle column C of the main nozzle group are aligned with each other in the sheet width direction, and the cyan nozzle column C of the sub nozzle group and the black nozzle column K of the main nozzle group are aligned with each other in the sheet width direction. However, neither the yellow nozzle column Y of the main nozzle group nor the black nozzle column K of the sub nozzle group is aligned with the nozzle columns of ejecting other color inks, in the sheet width direction. In this manner, among the nozzle columns included in the head 31, some nozzle columns of the main nozzle group and some nozzle groups of the sub nozzle group that eject different liquids are aligned along a straight line in the sheet width direction.

In addition, in the sub nozzle group, the number of nozzles is decreased by the number of nozzles of a nozzle column (for example, the yellow nozzle column Y) at the upstream side of the transport direction. On the contrary, in the main nozzle group, the number of nozzles is increased by the number of nozzles of the nozzle column at the upstream side of the transport direction. As a result, in one head 31, each nozzle column has the same number of nozzles.

The nozzles of each nozzle column are aligned in the sheet width direction with an interval of 800 dpi (corresponding to the predetermined interval), which is called “nozzle pitch=800 dpi”. In addition, with respect to the same color nozzle columns of adjacent heads 31(1) and 31(2), the interval between the nozzle (for example, nozzle #N of the main nozzle group in the yellow nozzle column Y) at the right end portion of the main nozzle group of the left head 31(1) in the sheet width direction and the nozzle (for example, nozzle #1 of the sub nozzle group in the yellow nozzle column Y) at the left end portion of the sub nozzle group of the right head 31(2) becomes 800 dpi. In addition, with respect to the same color nozzle columns in the same head 31(2), the interval between the nozzle (for example, nozzle #n of the sub nozzle group in the yellow nozzle column) at the right end portion of the sub nozzle group and the nozzle (for example, nozzle #1 of the main nozzle group in the yellow nozzle column) at the left end portion of the main nozzle group becomes 800 dpi. For this reason, the nozzles can be aligned in the sheet width direction at the interval of 800 dpi to extend along the sheet width length. In addition, since the transport-direction positions at the end portions of the nozzle columns are not uniform as shown in FIG. 3A, the range in which the nozzles of all the nozzle columns are included becomes the maximum printing range.

In general, as shown in FIG. 3B, the distance between an edge portion of the head 31 and an end portion of a nozzle column is larger than the nozzle pitch (800 dpi). Therefore, similarly, if the heads having nozzle columns where the nozzles are aligned are simply aligned in the sheet width direction, the sheet width direction interval between the end nozzle of the one head and the end nozzle of the other head becomes larger than the nozzle pitch in the joint portion of the heads. However, in the embodiment, as described above, since the nozzle column of the sub nozzle group is disposed to be shifted from the nozzle column of the main nozzle group in the transport direction, the sheet width direction interval between the end nozzles of the adjacent heads 31 can be set to be the nozzle pitch (800 dpi) even in the joint portion of the heads 31. As a result, it is possible to align the nozzles at a predetermined nozzle pitch to extend along the sheet width length.

In addition, since the nozzles are aligned in the sheet width direction at the predetermined interval, in a case where the nozzle groups having the same number of nozzles (the heads including the nozzle columns having the same length) are aligned in the sheet width direction to be shifted in the transport direction (that is, a case where the nozzle groups are disposed in a zigzag) as in Patent Document JP-A-10-291310, the head unit is lengthened in the transport direction, so that the size of the printing apparatus is greatly increased.

In the embodiment, as shown in FIGS. 3A and 3B, the main nozzle group of each head 31 is aligned in the sheet width direction so as not to be shifted in the medium transport direction, and the sub nozzle group disposed at the joint portion of the heads 31 is aligned to be shifted in the medium transport direction with respect to the main nozzle group. As a result, it is possible to equalize the sheet width direction intervals between the nozzles disposed at the joint portion of the heads 31. In addition, the length of the head unit 30 in the medium transport direction can be decreased, so that it is possible to prevent the printing apparatus from being greatly increased. In addition, the number of sub nozzle groups can be set to be smaller than that of the main nozzle groups.

In addition, since the nozzles of the main nozzle group where a large portion of the nozzles among the nozzles included in the head unit 30 are included are disposed in a straight line in the nozzle column direction, the misalignment adjustment amount of the impact positions of the dots ejected from the nozzles of the main nozzle group becomes small. If the main nozzle group is disposed to be shifted in the medium transport direction as in Patent Document JP-A-10-291310, the misalignment adjustment amount of the impact positions of the dots of each main nozzle groups becomes large and the time for shifting the printing timing is also increased. Therefore, the printing data need to be stored in a buffer during a time corresponding to the time for shifting the printing timing. In addition, the misalignment amount between the sub nozzle group and the main nozzle group in the medium transport direction becomes equal to the misalignment amount of the interval between adjacent nozzle columns in the head 31, which is lowered in comparison with the aforementioned case of Patent Document JP-A-10-291310. For this reason, with respect to the main nozzle group and the sub nozzle group, the time for shifting the printing timings can be decreased, and the time for storing the printing data in the buffer can be decreased.

In addition, in the head 31 of the embodiment, the number of nozzles of the sub nozzle group can be set to be smaller than that of the main nozzle group. More specifically, with respect to the nozzles ejecting the same liquid, a large number of the nozzles included in the main nozzle group are aligned in a straight line in the sheet width direction, and a small number of the nozzles included in the sub nozzle group are disposed to be shifted from the main nozzle group in the transport direction. Since the main nozzle group and the sub nozzle group are disposed to be shifted from each other in the transport direction, there is a need to adjust the timing of ejecting the liquid from each nozzle group (described later in detail). Therefore, in the head 31 of the embodiment, the sub nozzle group can be set to be smaller than the main nozzle group, so that the dots can be aligned in the sheet width direction without a need to adjust the ejecting timings of as many nozzles as possible. As a result, it is possible to further suppress deterioration in image quality. In addition, when the ink (liquid) ejected from the nozzle is impacted on the sheet, the sheet is expanded and contracted due to a solvent ingredient (water) of the ink. Since the main nozzle group and the sub nozzle group eject the liquid in the region of the sheet where the positions in the transport direction are the same, if the number of nozzles of the sub nozzle group is set to be smaller than that of the main nozzle group and the liquid is ejected simultaneously from as many nozzles (of the main nozzle group) as possible, the number of nozzles (of the sub nozzle group) that are influenced by the expansion and contraction of the sheet due to the liquid ejected from the nozzles can be decreased. In addition, it is possible to further suppress deterioration in image quality.

### Ink Ejection

### Head Controller HC

Now, a mechanism that ejects the ink (liquid) from each nozzle will be described.

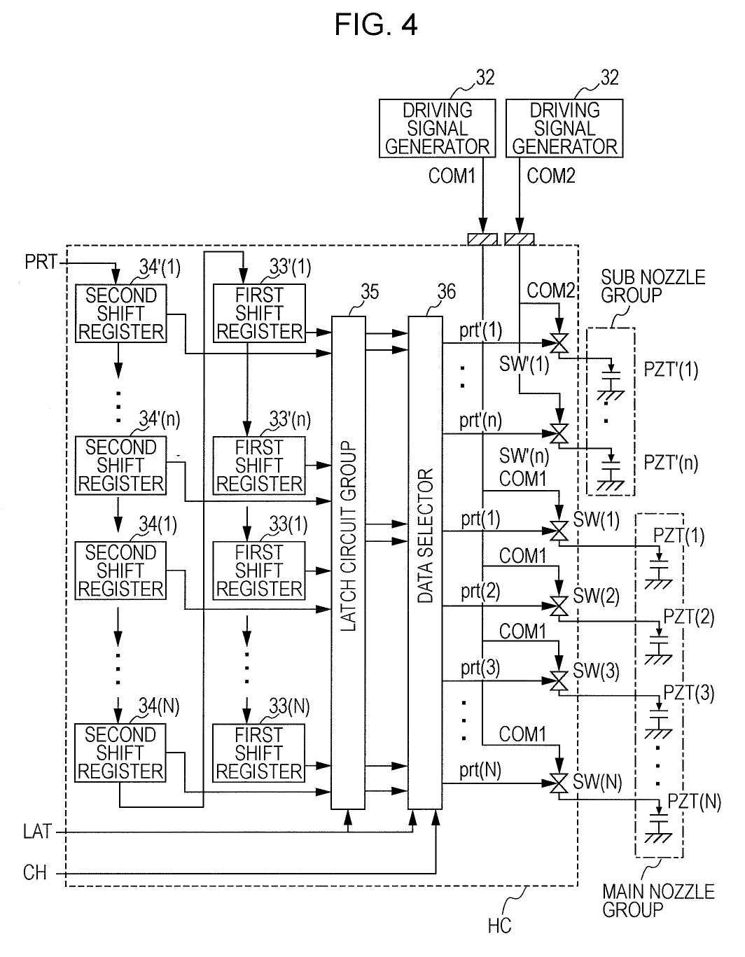

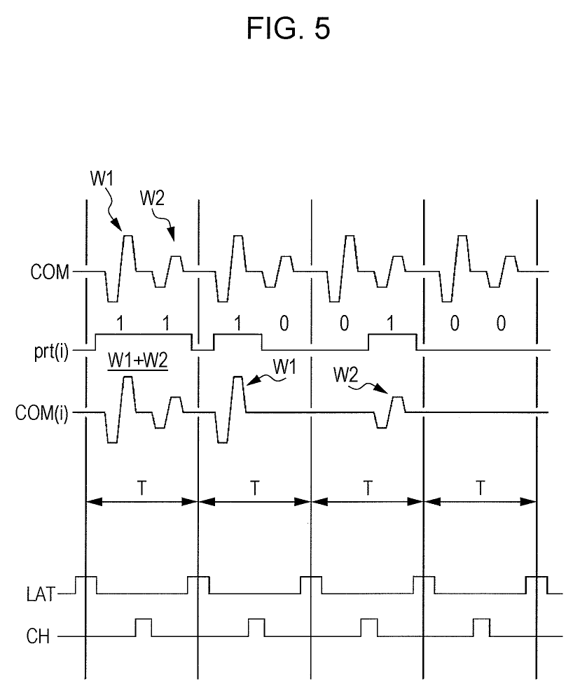

FIG. 4 is an electronic circuit view showing the operations of a driving device PZT controlled by the driving signal generator 32 and a head controller HC. FIG. 5 is a timing chart showing timings of signals. The head unit 30 includes the head controller HC and the driving signal generator 32 (described later). The head controller HC includes first shift registers 33 and second shift registers 34, of which number corresponds to the number of to-be-driven nozzles, switches SW, a latch circuit group 35, and a data selector 36. The head controller HC drives each of the piezo devices PZT corresponding to the nozzles included in one head 31 based on serially-transmitted printing signals PRT to eject the ink from each nozzle. The head controller HC is provided to each nozzle column of each head 31.

The printing signal PRT(i) is a signal corresponding to a pixel data allocated to one pixel covered by the nozzle #i. In the embodiment, the printing signal PRT(i) is defined to have 2 bits for one pixel. Firstly, if the printing signals PRT(i) corresponding to the number of nozzles are serially transmitted to the first shift registers 33 and the second shift registers 34 of the head controller HC, the printing signals PRT(i) are converted into a parallel data. Next, when a rising pulse of a latch signal LAT is input to the latch circuit group 35, data of the shift registers are latched in the latch circuit group 35. At the same time, the data selector 36 is reset to an initial state.

Next, before the next latch signal LAT is input, the data selector 36 converts the printing signals PRT(i) that are 2-bit data latched in the latch circuit group 35 into switch control signals prt(i) and outputs the switch control signals prt(i) to the switches SW(i). The driving signal COM from each of the driving signal generators 32 is also input to the switches SW. As shown in FIG. 5, the driving signal COM has two driving pulses W1 and W2 in one repeating period T. When the switch control signal prt(i) has a level of 1, the switch SW(i) passes the corresponding driving pulse W of the driving signal COM. On the contrary, when the switch control signal prt(i) has a level of 0, the switch SW(i) blocks the corresponding driving pulse W of the driving signal COM. For this reason, strictly speaking, the driving pulse W of the driving signal COM used for ejecting the liquid from the nozzle is input to the driving device (piezo device) corresponding to the nozzle. However, hereinafter, it is written, for convenience of description, that the driving signal COM is input to the driving device.

When the driving pulses W1 and W2 are applied to the piezo devices PZT(i), the piezo devices PZT(i) are deformed. Accordingly, an elastic membrane (side wall) partitioning some portions of the pressure chamber filled with the ink is deformed, so that the ink in the pressure chamber can be ejected from the nozzle #i. For this reason, the waveforms of the driving pulses W1 and W2 are defined according to the ink amount ejected from the nozzle. In other words, it is possible to form dots having different sizes by using a difference in the waveforms of the driving pulses W.

In the embodiment, one pixel is set to be represented by four gradations. In addition, as shown in FIG. 5, if the switch control signal prt(i) is “11”, the driving pulses W1 and W2 are input to the piezo device PZT(i), so that a large-sized dot is formed. Similarly, if the switch control signal prt(i) is “10”, the first driving pulse W1 is applied to the piezo device PZT(i), so that a medium-sized dot is formed. If the switch control signal prt(i) is “01”, the second driving pulse W2 is input to the piezo device PZT(i), so that a small-sized dot is formed. If the switch control signal prt(i) is “00”, no dot is formed.

### Driving Signal Generator 32

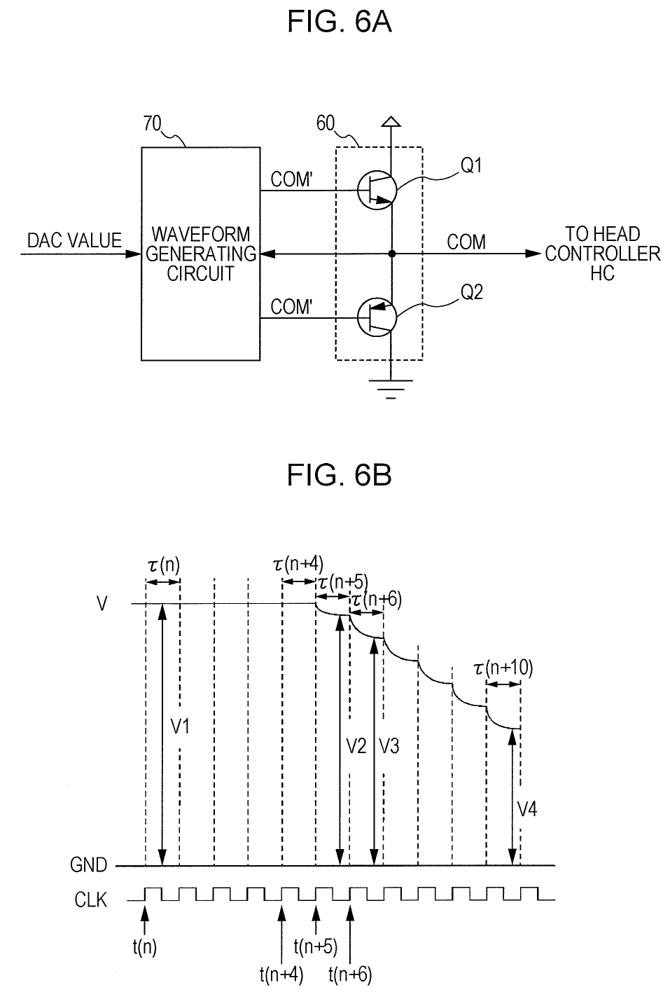

FIG. 6A is a view showing the driving signal generator 32. FIG. 6B is a view for explaining the operations of a waveform generating circuit 70. The driving signal generator 32 includes the waveform generating circuit 70 and a current amplifying circuit 60.

DAC values are sequentially output from the controller 10 to the waveform generating circuit 70 every updating period τ. In the example of FIG. 6B, the DAC values corresponding to a voltage V1 are output at the timing t(n) defined by a clock CLK. Therefore, in the period τ(n), the voltage V1 is output from the waveform generating circuit 70. In addition, until the updating period τ(n+4), the DAC values corresponding to the voltage V1 are sequentially input from the controller 10 to the waveform generating circuit 70, and the voltage V1 is continuously output. In addition, at the timing t(n+5), the DAC values corresponding to a voltage V2 are input from the controller 10 to the waveform generating circuit 70. Therefore, in the period τ(n+5), the output of the waveform generating circuit 70 is dropped from the voltage V1 to the voltage V2. Similarly, in the timing t(n+6), the DAC values corresponding to a voltage V3 are input from the controller 10 to the waveform generating circuit 70, so that the output thereof is dropped from the voltage V2 to the voltage V3. Similarly, since the DAC values are sequentially input to the waveform generating circuit 70, the output voltages are gradually dropped. As a result, in the period τ(n+10), the output of the waveform generating circuit 70 is dropped to a voltage V4. In this manner, voltage waveform signals COM' are output from the waveform generating circuit 70 to the current amplifying circuit 60.

Next, the current amplifying circuit 60 amplifies a current corresponding to the voltage waveform signals COM' input from the waveform generating circuit 70 and outputs the amplified current signal as a driving signal COM. The current amplifying circuit 60 amplifies the current so as to drive a number of piezo devices. The output of the current amplifying circuit 60 is fed back to the current amplifying circuit 60.

In addition, the current amplifying circuit 60 includes a rising transistor Q1 (NPN transistor) that is operated at the time the voltage of the driving signal COM rises and a falling transistor Q2 (PNP transistor) that is operated at the time the voltage of the driving signal COM falls. If the rising transistor Q1 enters the ON state in response to the voltage waveform signal COM' from the waveform generating circuit 70, the driving signal COM is rising, and the piezo device PZT is charged. On the contrary, if the falling transistor Q2 enters the ON state in response to the voltage waveform signal COM', the driving signal COM is falling, and the piezo device PZT is discharged.

### Adjustment of Dot Forming Positions Between Main Nozzle Group and Sub Nozzle Group

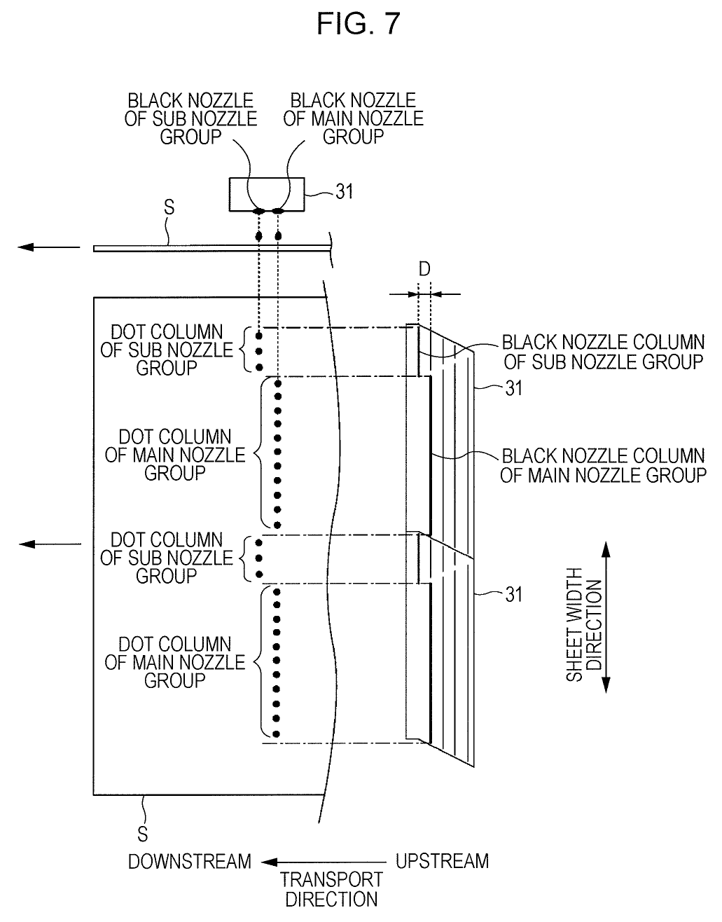

FIG. 7 a view showing dot positions formed by simultaneously ejecting liquids from a black nozzle column K of a main nozzle group and a black nozzle column K of a sub nozzle group. As shown in FIG. 3B, the black nozzle column K of the sub nozzle group is disposed to be shifted from the black nozzle column K of the main nozzle group in the downstream side in the transport direction. Therefore, if the liquids are simultaneously ejected from the black nozzle columns K of the main nozzle group and the sub nozzle group according to a common driving signal COM, as shown in the figure, the dot columns formed by the sub nozzle group are positioned at the downstream side in the transport direction with respect to the dot columns formed by the main nozzle group. For this reason, there is a need to adjust the timings of ejecting the liquids from the nozzle columns of the main nozzle group and the sub nozzle group so that the dot columns formed by the main nozzle group and the sub nozzle group that eject the same liquid are aligned in a straight line in the sheet width direction. If the adjustment is not performed, image quality is deteriorated.

In the embodiment, although the nozzle columns eject the same liquid in the same head 31, the nozzle column of the main nozzle group and the nozzle column of the sub nozzle group are shifted from each other in the transport direction and the liquid ejecting timing needs to be adjusted. Therefore, the driving signal COM for ejecting a liquid from the nozzle column of the main nozzle group and the driving signal COM for ejecting the same liquid from the nozzle column of the sub nozzle group are set to be different from each other. As shown in FIG. 4, in a case where the nozzles ejecting the same ink are provided with a common head controller HC, the driving signal COM1 for ejecting the liquid from the nozzle column of the main nozzle group and the driving signal COM2 for ejecting the liquid from the nozzle column of the sub nozzle group are input to the common head controller HC.

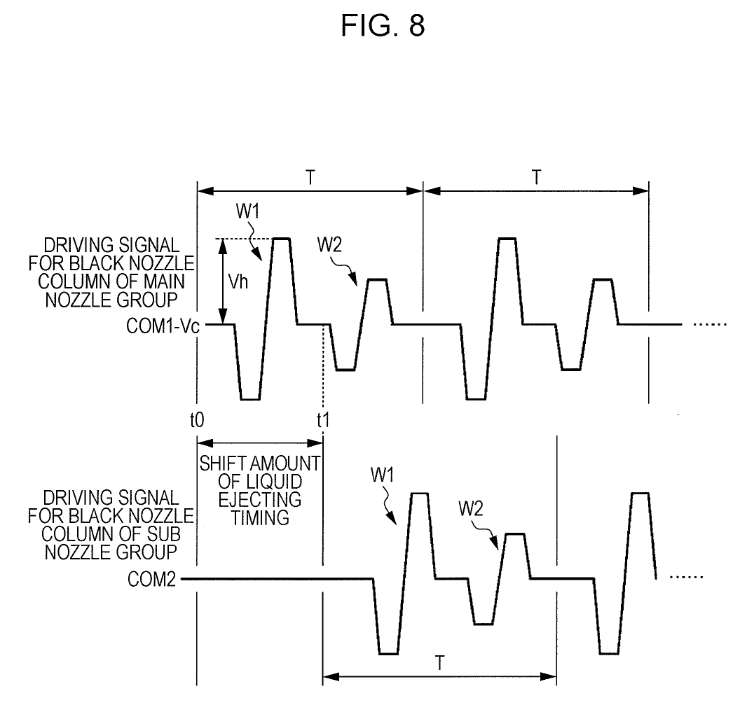

FIG. 8 is a view showing the difference between a driving signal COM1 for ejecting a liquid from a black nozzle column K of the main nozzle group and a driving signal COM2 for ejecting a liquid from a black nozzle column K of the sub nozzle group. A repeating period T of the driving signal COM1 of the black nozzle column K of the main nozzle group starts from a time point t0. On the other hand, a repeating period T of the driving signal COM2 of the black nozzle column K of the sub nozzle group starts from a time point t1. In other words, the black nozzle column K of the main nozzle group ejects the liquid from the time point t0 to the time point t0+T, and the black nozzle column K of the sub nozzle group ejects the liquid from the time point t1 to the time point t1+T. The difference between the time point t0 and the time point t1 becomes a misalignment amount of liquid ejecting timing between the main nozzle group and the sub nozzle group. In this manner, by adjusting the timing of generating the driving pulse W of the driving signal COM1 of the main nozzle group and the timing of generating the driving pulse W of the driving signal COM2 of the sub nozzle group, it is possible to adjust the liquid ejecting timings of the nozzles.

For example, as shown in FIG. 7, it is assumed that a transport-direction interval (distance) between the black nozzle column K of the main nozzle group and the black nozzle column K of the sub nozzle group is “D”. In this case, the liquid is ejected from the main nozzle group, and after the sheet S is transported by a length of “D” in the transport direction, the liquid is ejected from the sub nozzle group. As a result, the dot column of the main nozzle group and the dot column of the sub nozzle group can be aligned in a straight line in the sheet width direction. In this case, the time when the sheet S is transported by the length of “D” corresponds to the difference between the time point t0 and the time point t1. Similarly, with respect to the other nozzle columns, the liquid ejecting timings may be adjusted by shifting the timing of generating the driving pulse W of the driving signal COM by the time when the sheet S is transported by a length of the transport-direction interval between the nozzle column of the main nozzle group and the nozzle column of the sub nozzle group that ejects the same color liquid as that of the nozzle column of the main nozzle group.

In this manner, since the driving signal COM1 input to the driving device corresponding to the nozzle column of the main nozzle group and the driving signal COM2 input to the driving device corresponding to the nozzle column of the sub nozzle group are set to be different from each other, during the time when the liquid is ejected from the nozzle column of the main nozzle group, the liquid can start to be ejected from the nozzle column of the sub nozzle group. Therefore, even in a case where the adjustment amounts of the liquid ejecting timings of the nozzle column of the main nozzle group and the nozzle column of the sub nozzle group are very small (even in a case where the timings need to be adjusted more finely than the timing corresponding to one pixel or the repeating period T), it is possible to adjust the liquid ejecting timing. As a result, the dot column formed by the main nozzle group and the dot column formed by the sub nozzle group can be more accurately aligned in a straight line in the sheet width direction. In addition, it is possible to suppress deterioration in image quality.

In other words, in the embodiment, the nozzle column ejecting the same liquid in the same head 31 also ejects the liquid according to the other driving signals COM so as to adjust the liquid ejecting timing. Accordingly, the dots formed by the same liquid can be aligned in a straight line in the sheet width direction, so that it is possible to suppress deterioration in image quality.

In addition, in a case where the misalignment amount (adjustment amount) between the liquid ejecting timings of the main nozzle group and the sub nozzle group is larger than the repeating period T, the misalignment amounts of the liquid ejecting timings that are larger than the repeating period T may be adjusted in units of the repeating period T (for example, by adjusting the switch control signal SW' of FIG. 4), and the other misalignment amounts may be adjusted based on the difference of the starting time between the driving signal COM1 of the main nozzle group and the driving signal COM2 of the sub nozzle group. Alternatively, all the misalignment amounts of the liquid ejecting timings may be adjusted based on the misalignment amount of the starting time between the driving signals COM1 and COM2.

### Head Driving Circuit:

### CIRCUIT EXAMPLE 1

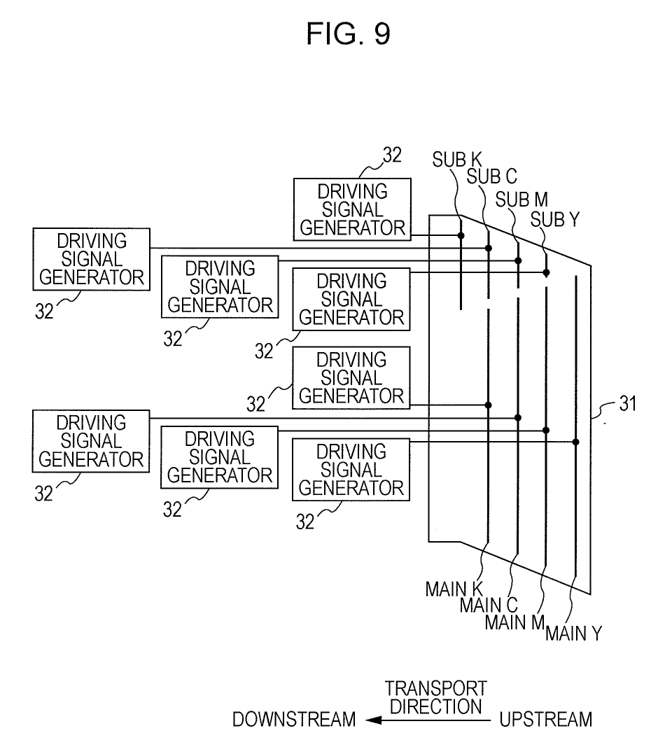

FIG. 9 is a schematic view showing a head driving circuit according to a comparative example other than the embodiment. In the embodiment, driving signals COM for the nozzle column of the main nozzle group and the nozzle column of the sub nozzle group that eject the same liquid are set to be different from each other in order to adjust the liquid ejecting timing. Therefore, in the comparative example (FIG. 9), the driving signal generators 32 are individually provided to eight nozzle columns, that is, four nozzle columns YMCK of the main nozzle group and four nozzle columns YMCK of the sub nozzle group. As a result, the transport-direction positions of the dot columns formed by the nozzle columns of the main nozzle group and the sub nozzle group that eject the same liquid can be uniformly disposed. For example, the dot column formed by the black nozzle column K of the main nozzle group and the dot column formed by the black nozzle column K of the sub nozzle group are aligned in a straight line in the sheet width direction, so that it is possible to suppress deterioration in image quality. Similarly, the dot columns formed by the nozzle columns of the main nozzle group and the sub nozzle group corresponding to the other colors can be aligned in a straight line in the sheet width direction.

As described in the comparative example (FIG. 9), by providing the driving signal generator 32 to each of the nozzle columns of the head 31, deterioration in image quality can be suppressed. However, in such a head 31 of the embodiment, if the head 31 ejecting four color inks YMCK includes eight nozzle columns and if one driving signal generator 32 is provided to each of the nozzle columns of the sub nozzle group that have a small number of nozzles, cost is increased. In addition, the head driving circuit is also complicated.

Therefore, in the embodiment, by uniformly disposing the transport-direction positions of the dot columns formed by the nozzle column of the main nozzle group and the nozzle column of the sub nozzle group that eject the same liquid, it is intended to suppress deterioration in image quality and to reduce cost.

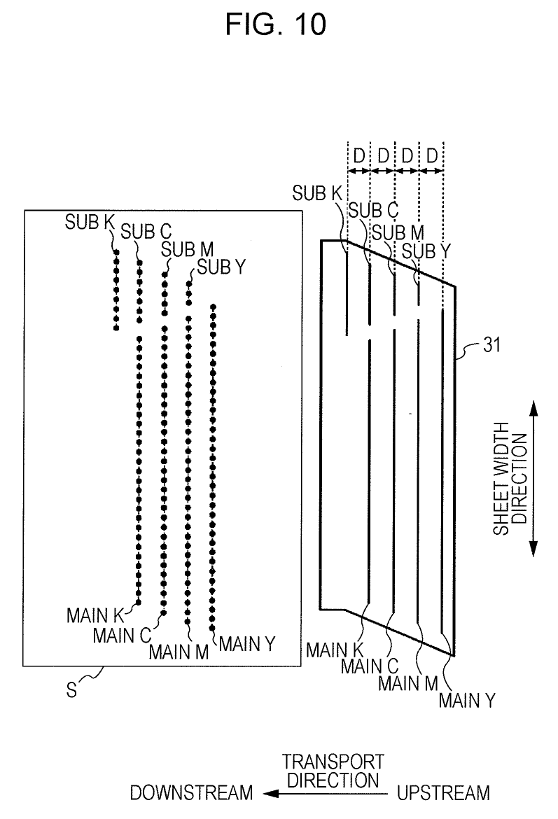

FIG. 10 is a view showing dot positions formed on the sheet S by simultaneously ejecting liquids from eight nozzle columns of one head 31. As described above, the dot columns formed by the nozzle column of the main nozzle group and the nozzle column of the sub nozzle group that eject the same liquid are shifted from each other in the transport direction. However, as shown in FIG. 3B, some nozzle columns of the head 31 according to the embodiment, the nozzle columns of the main nozzle group and the nozzle columns of the sub nozzle group that eject different liquids are aligned in the sheet width direction. For this reason, when the liquids are simultaneously ejected, the dot columns formed by the different liquids are aligned in the sheet width direction as shown in the figure. For example, the dot column (sub C) formed by the cyan nozzle column of the sub nozzle group and the dot column (main K) formed by the black nozzle column of the main nozzle group have the same transport-direction positions and are aligned in the sheet width direction.

A printed image is constructed by aligning virtually-defined pixels on the sheet S in the transport direction and the sheet width direction, that is, two-dimensionally. In addition, in color printing, four color dots (YMCK) are selectively formed at each pixel according to printing data, so that various colors can be expressed. In other words, there is a need to form the four color dots (YMCK) at the same position (pixel) on the sheet. Therefore, in addition to uniformly disposing the transport-direction positions of the dot columns formed by the nozzle columns of the main nozzle group and the sub nozzle group that eject the same liquid, there is a need to uniformly dispose the transport-direction positions of the dot columns formed by the nozzle columns of the main nozzle group and the sub nozzle group that eject different liquids.

In the head 31 of the embodiment, the transport-direction positions of the nozzle columns of ejecting different liquids, for example, the cyan nozzle column (sub C) of the sub nozzle group and the black nozzle column (main K) of the main nozzle group are uniformly disposed. Therefore, the cyan nozzle column of the sub nozzle group and the black nozzle column of the main nozzle group can form dots at the same position (the same pixel) in the transport direction without a need to adjust the liquid ejecting timings. Since there is no need to adjust the liquid ejecting timings, a driving signal COM input to the driving devices corresponding to the cyan nozzle column of the sub nozzle group and the black nozzle column of the main nozzle group can be commonly used.

Similarly, since the transport-direction positions of the magenta nozzle column (sub M) of the sub nozzle group and the cyan nozzle column (main C) of the main nozzle group are the same, a driving signal COM can be used by both. In addition, since the transport-direction positions of the yellow nozzle column (sub Y) of the sub nozzle group and the magenta nozzle column (main M) of the main nozzle group are the same, a driving signal COM can be used by both.

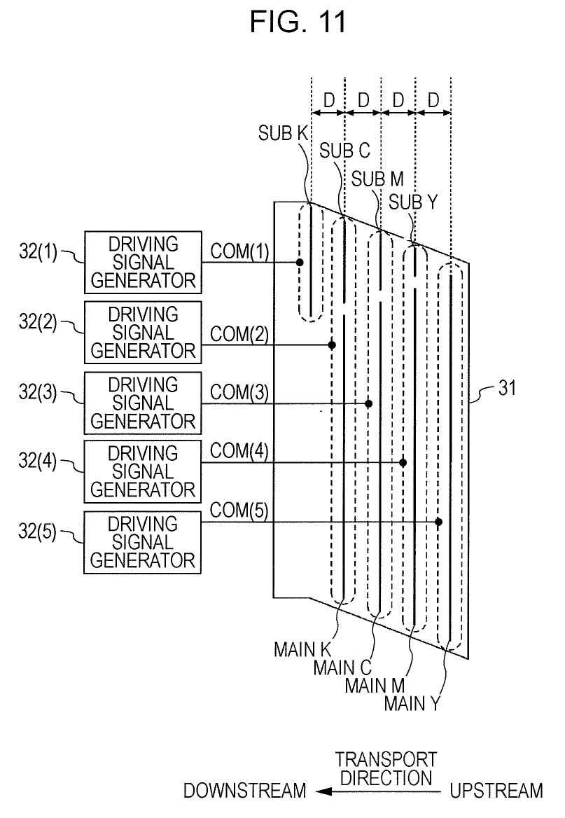

FIG. 11 is a schematic view showing a head driving circuit according to the embodiment. In the circuit example 1, one driving signal generator 32(1) is provided to the black nozzle column (sub K, corresponding to the fourth nozzle column) of the sub nozzle group, and one driving signal generator 32(5) is provided to the yellow nozzle column (main Y, corresponding to the first nozzle column) of the main nozzle group. In addition, a common driving signal generator 32(2) is provided to the cyan nozzle column (sub C, corresponding to the second nozzle column) of the sub nozzle group and the black nozzle column (main K, corresponding to the third nozzle column) of the main nozzle group. A common driving signal generator 32(3) is provided to the magenta nozzle column (sub M, corresponding to the second nozzle column) of the sub nozzle group and the cyan nozzle column (main C, corresponding to the third nozzle column) of the main nozzle group. A common driving signal generator 32(4) is provided to the yellow nozzle column (sub Y, corresponding to the second nozzle column) of the sub nozzle group and the magenta nozzle column (main M, corresponding to the third nozzle column) of the main nozzle group.

In the head driving circuit, the time difference between the timing of generating the driving pulse W of the driving signal COM(1) generated by the driving signal generator 32(1) and the timing of generating the driving pulse W of the driving signal COM(2) generated by the driving signal generator 32(2) is defined to be the time when the sheet S is transported along the length of transport-direction interval D between the black nozzle columns K of the main nozzle group and the sub nozzle group. Therefore, with respect to the pixel columns that are aligned in the determined sheet width direction on the sheet S, the liquid is ejected from the black nozzle column (sub K) of the sub nozzle group, and after the sheet S is transported by only the length D, the liquid can be ejected from cyan nozzle column (sub C) of the sub nozzle group and the black nozzle column (main K) of the main nozzle group. As a result, the dot columns formed by the nozzle columns of the main nozzle group and the sub nozzle group that eject the same liquid can be formed.

Next, similarly, after the sheet S is transported by the length of transport-direction interval D between the nozzle columns (for example, main C and sub C) of the main nozzle group and the sub nozzle group that eject the same liquid, the liquid is ejected from the nozzle columns (for example, main C and sub M) of the main nozzle group and the sub nozzle group that eject different liquids and are aligned in the sheet width direction. As a result, the dot columns of the four colors YMCK can be formed to overlap at the pixel column where the transport-direction positions are the same. According to the head driving circuit (FIG. 11) of the circuit example 1, four color dots (YMCK) can be selectively formed at each pixel on the sheet S in response to the printing data, and deterioration in image quality can be suppressed.

In addition, by providing one common driving signal generator (for example, 32(2)) to the nozzle columns (for example, sub C and main K) of the main nozzle group and the sub nozzle group that eject different liquids and are aligned in the sheet width direction, the number of driving signal generators 32 in the head driving circuit (FIG. 11) of the circuit example 1 can be reduced (from 8 to 5) in comparison with the head driving circuit (FIG. 9) of the comparative example. As a result, it is possible to reduce cost.

In other words, by uniformly disposing the transport-direction positions of the nozzle columns of the main nozzle group and the sub nozzle group that eject different liquids, it is possible to decrease the number of the driving signal generators 32 and to reduce cost. For example, if the black nozzle column (main K) of the main nozzle group and the cyan nozzle column (sub C) of the sub nozzle group are shifted in the transport direction, there is a need to adjust the liquid ejecting timings of the cyan nozzle column (sub C) of the sub nozzle group and the black nozzle column (main K) of the main nozzle group. Therefore, similarly to the comparative example (FIG. 9), there is a need to provide the driving signal generator 32 to each of the eight nozzle columns of the head 31, incurring increased cost.

In other words, in the embodiment, with respect to the nozzle columns (for example, sub K and main K) that eject the same liquid and are shifted in the transport direction, the liquid is ejected according to different driving signals COM. With respect to the nozzle columns (for example, sub C and main K) that eject different liquids and are aligned in the sheet width direction, the liquid is ejected according to a common driving signal COM. Accordingly, the number of driving signal generators 32 can be decreased by as many as possible, and cost can be reduced.

More specifically, the head 31 according to the embodiment includes an input unit (not shown) to which the driving signal COM(1) for ejecting the liquid from the black nozzle column K of the sub nozzle group is input, an input unit to which the driving signal COM(2) for ejecting the liquids from the cyan nozzle column C of the sub nozzle group and the black nozzle column K of the main nozzle group is input, an input unit to which the driving signal COM(3) for ejecting the liquids from the magenta nozzle column M of the sub nozzle group and the cyan nozzle column C of the main nozzle group is input, an input unit to which the driving signal COM(4) for ejecting the liquids from the yellow nozzle column Y of the sub nozzle group and the magenta nozzle column M of the main nozzle group is input, and an input unit to which the driving signal COM(5) for ejecting the liquid from the yellow nozzle column Y of the main nozzle group is input.

In addition, the adjustment amount of the liquid ejecting timings of the nozzle columns to enable the dot columns of the four colors YMCK along the sheet width direction to be formed at the same transport-direction position is determined based on the transport direction misalignment amount D of the nozzle columns of the main nozzle group and the sub nozzle group. Therefore, for example, as a test pattern, the liquids are simultaneously ejected from the nozzles of the head 31 as shown in FIG. 10, and the liquid ejecting timings of the nozzle columns may be adjusted based on the actual transport-direction interval of the dot columns formed by the nozzle columns of the main nozzle group and the sub nozzle group. As a result, in the design, as well as the transport-direction interval D of the nozzle columns of the main nozzle group and the sub nozzle group, the liquid ejecting timing can be adjusted by taking into consideration a transport error, a nozzle manufacturing error, or the like, so that it is possible to further suppress deterioration in image quality.

In addition, the invention is not limited thereto. Alternatively, the dot columns may be formed by the liquid ejected from the nozzle column (for example, sub K) of the sub nozzle group, and after the sheet S is transported by the transport-direction interval D between the nozzle column (for example, sub K) of the sub nozzle group and the nozzle column (for example, main K) of the main nozzle group that ejects the same liquid, the liquid is ejected from the nozzle column (for example, main K) of the main nozzle group, so that the test pattern may be formed. In this case, since the transport direction misalignment amount of the dot columns formed by the nozzle columns of the main nozzle group and the sub nozzle group corresponds to the transport error or nozzle manufacturing error, the liquid ejecting timing may be adjusted by taking into consideration such errors.

In addition, the transport-direction interval D of the nozzle columns of the main nozzle group and the sub nozzle group that eject the same liquid is an integer multiple of pixels (transport direction length). In this case, the switch control signal prt (or the LAT signal or the like) shown in FIG. 4 is adjusted, the liquid ejecting timing is shifted in pixel units by using a common driving signal COM, so that the dot columns formed by the nozzle columns of the main nozzle group and the sub nozzle group can be formed in a straight line in the sheet width direction. Therefore, for example, the transport-direction interval D of the yellow nozzle column (sub Y) of the sub nozzle group and the yellow nozzle column (main Y) of the main nozzle group shown in FIG. 11 becomes an integer multiple of the pixel. In a case where the yellow nozzle column (sub Y) of the sub nozzle group and the magenta nozzle column (main M) of the main nozzle group are aligned in the sheet width direction, the yellow nozzle columns (main Y and sub Y) of the main nozzle group and the sub nozzle group and the magenta nozzle column (main M) of the main nozzle group can be driven by a common driving signal COM.

However, due to a problem of electric power, there is a limitation in the number of driving devices that can be driven by the driving signal COM generated by one driving signal generator 32. Therefore, as shown in FIG. 11, different driving signal generators 32 are provided to the yellow nozzle columns of the main nozzle group and the sub nozzle group, and a common driving signal generator 32(4) is provided to the yellow nozzle column of the sub nozzle group and the magenta nozzle column of the main nozzle group. As a result, the driving devices can be reliably driven by the driving signal COM. In addition, even though the transport-direction interval D of the yellow nozzle columns of the main nozzle group and the sub nozzle group is not an integer multiple of pixels due to the transport error or the like, the yellow nozzle columns of the main nozzle group and the sub nozzle group can be aligned in a straight line in the sheet width direction. According to the circuit example 1, it is possible to accurately adjust the dot forming positions formed by the nozzle columns of the main nozzle group and the sub nozzle group.

In addition, with respect to the nozzle columns where the different driving signals COM are used, the liquid ejecting amount as well as the dot forming position can be corrected. For example, in a case where there is a variation in the liquid ejecting amount in the black nozzle column (sub K) of the sub nozzle group and the black nozzle column (main K) of the main nozzle group, a voltage difference Vh between the medium-sized voltage Vc and the maximum voltage of the driving signal COM shown in FIG. 8 may be adjusted.

### Head Driving Circuit:

### CURCUIT EXAMPLE 2

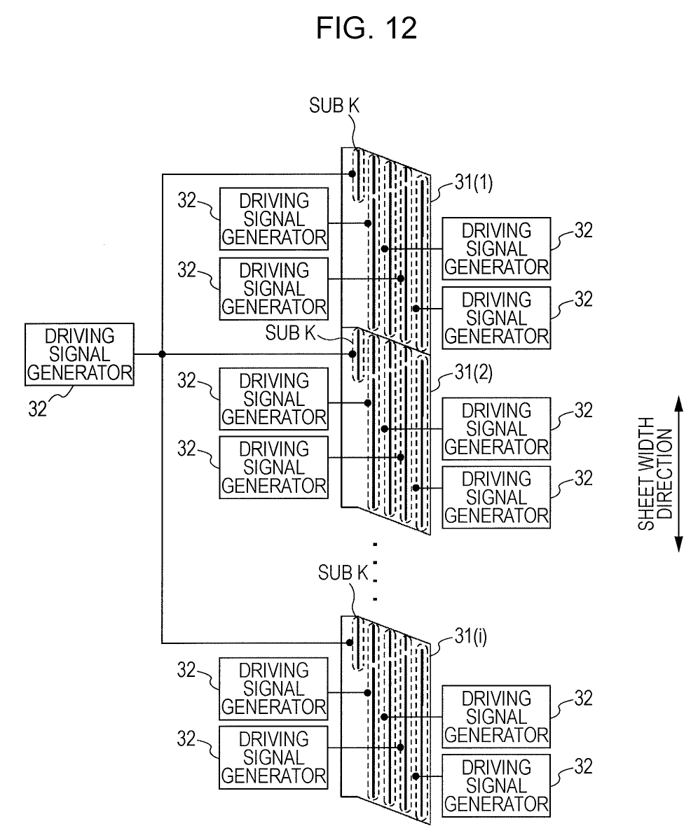

FIG. 12 is a schematic view showing a head driving circuit according to a circuit example 2. In the aforementioned circuit example 1 (FIG. 11), the one driving signal generator 32(1) and the driving signal generator 32(5) are provided to the one black nozzle column (sub K) of the sub nozzle group and the yellow nozzle column (main Y) of the main nozzle group, respectively. As described above, there is a limitation in the number of driving devices that can be driven by a driving signal COM generated by one driving signal generator 32. Therefore, with respect to the yellow nozzle column (main Y) of the main nozzle group of which the number of nozzles is larger than that of the sub nozzle group, since the one driving signal generator 32(5) is provided to each of the heads 31, the driving device can be reliably driven.

On the other hand, with respect to the black nozzle column (sub K) of the sub nozzle group of which the number of nozzles is smaller than that of the main nozzle group, in the circuit example 1, one driving signal generator 32(1) is provided to each of the heads 31. In other words, the driving signal COM generated by one driving signal generator 32(1) can drive the driving devices corresponding the other nozzles in addition to the driving device corresponding to the black nozzle column (sub K) of one sub nozzle group.

Therefore, in the circuit example 2, a common driving signal generator 32 (corresponding to the third driving signal generator) is provided to the black nozzle columns (sub K, corresponding to the fourth nozzle columns) of a plurality of the sub nozzle groups in a plurality of the heads 31(1) to 31(i) that are aligned in the sheet width direction. Accordingly, the number (4×(the number (i) of heads)+1) of driving signal generators 32 in the circuit example 2 can be reduced by about ½ of the number of (8×(the number (i) of heads) of driving signal generators 32 in the comparative example (FIG. 9). As a result, it is possible to reduce cost. In addition, all the heads 31 have the same structure, and the transport-direction positions of the black nozzle columns (sub K) of the sub nozzle groups of each head 31 can be the same. Therefore, even in a case where a common driving signal COM is used for the black nozzle columns (sub K) of the sub nozzle groups in the other heads 31, there is no problem.

In addition, the number of driving signal generators 32 in the circuit example 2 (FIG. 12) can be further decreased in comparison with the circuit example 1 (FIG. 11), so that it is possible to reduce cost. However, in a case where a variation in the black nozzle columns of the sub nozzle group of each head 31 (that is, a variation in a dot diameter or a dot forming position) occurs due to a difference in characteristics of the head 31, in the circuit example 1, the driving signal COM can be adjusted according to the characteristics of the black nozzle columns of the sub nozzle group of each head 31, and deterioration in image quality can be further suppressed.

### Other Embodiments

In the aforementioned embodiment, a printer is mainly described. However, it is needless to say that a disclosure of a printing apparatus, a recording apparatus, a liquid ejecting apparatus, a printing method, a recording method, a liquid ejecting method, a printing system, a recording system, a computer system, a program, a storage medium of storing a program, or the like can be included therein.

In addition, although the printer or the like is described as an embodiment, the embodiment is provided to easily understand the invention, but not provided to limit or analyze the invention. The invention can be modified or reformed without departing from the sprit thereof. In addition, equivalents thereof are also included in the invention. Particularly, the embodiments described below are also included in the invention.

### Sub Nozzle Group

In the aforementioned embodiment, although the number of nozzles of a sub nozzle group is set to be smaller than the number of nozzles of a main nozzle group that eject the same liquid as the sub nozzle group, the invention is not limited thereto. For example, the number of nozzles of the sub nozzle group may be equal to or larger than that of the main nozzle group. In this case, since the sum of the number of nozzles of the main nozzle group and the sub nozzle group (for example, the main nozzle group of black and the sub nozzle group of cyan) that are aligned in the nozzle column direction (the predetermined direction) is increased, a common driving signal generator for generating a driving signal to be input to the main nozzle group and the sub nozzle group that are aligned in the nozzle column direction may be constructed with a driving signal generator which can drive a large number of nozzles.

### Liquid Ejecting Apparatus

In the aforementioned embodiment, although an ink jet printer is provided as an example of an liquid ejecting apparatus, the invention is not limited thereto. Various industrial apparatuses that are a liquid ejecting apparatus, but not a printer (printing apparatus), can be adapted. For example, a textile printing apparatus for printing a design on a cloth, a color filter manufacturing apparatus, an apparatus for manufacturing a display such as an organic EL display, an apparatus for manufacturing a DNA chip by coating a DNA-dissolved solution on a chip, or the like can be adapted to the invention.

In addition, as a method of ejecting the liquid, a piezo method of ejecting the liquid through the expansion and contraction of an ink chamber by applying a voltage to a driving device (piezo device) or a thermal method of generating bubbles in a nozzle by using a heating device and ejecting the liquid by the bubbles may be adapted.

In the aforementioned embodiment, although a line head printer for transporting a medium under the nozzles that are aligned in the sheet width direction is exemplified, the invention is not limited thereto. For example, a printing apparatus for forming an image by moving a plurality of heads that are aligned in the nozzle column direction, in a direction intersecting the nozzle column direction with respect to a medium or a printing apparatus which alternately repeats an operation of forming an image by moving a plurality of the heads that are aligned in the direction intersecting the nozzle column direction and a transport operation of relatively moving the heads and the medium in the nozzle column direction may be used.

### Driving Signal Generator 32

In the aforementioned embodiment, there is a limitation on the number of driving devices that can be driven by a driving signal COM generated by one driving signal generator 32. For example, in the circuit example 1, the driving signal generator 32 is provided to each of the nozzle columns of each head 31 that are aligned in the sheet width direction (that is, every five columns of sub K, sub C and main K, sub M and main C, sub Y and main M, and main Y as shown in FIG. 11), but the invention is not limited thereto. For example, if there is a limitation on the number of driving devices that can be driven by the driving signal COM generated by one driving signal generator 32, a common driving signal generator 32 may be provided to the nozzle columns of a plurality of the heads 31 that are aligned in the sheet width direction. For example, a common driving signal generator 32 may be provided to the cyan nozzle column (sub C) of each sub nozzle group and the black nozzle column (main K) of each main nozzle group of the head 31(1) through the head 31(i).

In addition, as for the driving signal generator 32 in the aforementioned embodiment, the DAC value is input to the waveform generating circuit 70 (D/A converter), so that the DAC value is converted into the voltage waveform signal COM', that is, an analog signal by the waveform generating circuit 70. Next, the current of the voltage waveform signal COM' is amplified by the current amplifying circuit 60 constructed with the transistors Q1 and Q2, and after that, the amplified signal is input to the driving device. But, the invention is not limited thereto. For example, the DAC value (digital signal) is converted by the D/A converter, and after that, the analog-converted voltage waveform signal is pulse-converted. Next, the pulse-converted signal is power-amplified by a digital amplifier, and after that, the power-amplified signal is smoothed by a smoothing filter. The smoothed power-amplified signal is input to the driving device.

### Head Driving Circuit

In the aforementioned embodiment, in order to adjust the liquid ejecting timings of the nozzle columns shifted in the transport direction, for example, in the circuit example 1, the driving signal generator 32 is provided to each of the nozzle columns of each head 31 that are aligned in the sheet width direction (that is, every five columns of sub K, sub C and main K, sub M and main C, sub Y and main M, and main Y as shown in FIG. 11), but the invention is not limited thereto.

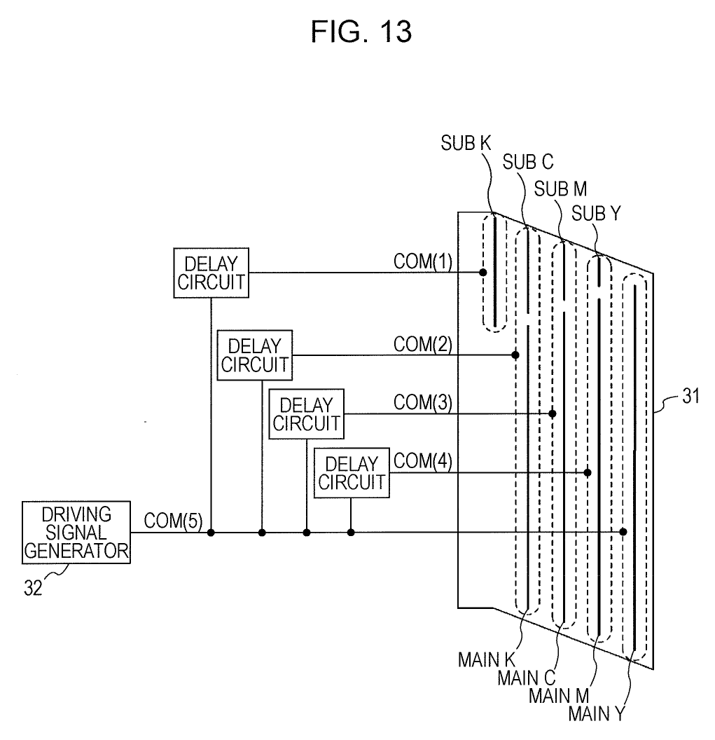

FIG. 13 is a schematic view showing a head driving circuit according to a modified example. For example, as shown in FIG. 13, one driving signal generator 32 may be provided to one head 31. At this time, the liquid is ejected from the yellow nozzle column (main Y) of the main nozzle group by the driving signal COM(5) generated by the driving signal generator 32. In addition, the driving signal COM(5) generated by the driving signal generator 32 is input to the delay circuit, and by the driving signal COM(4) output from the delay circuit, the liquid is ejected from the yellow nozzle column (sub Y) of the sub nozzle group and the magenta nozzle column (main M) of the main nozzle group that are aligned in the sheet width direction. Similarly, in the other nozzle columns, the driving signal COM(5) generated by the driving signal generator 32 is adjusted by the delay circuit so as to adjust the liquid ejecting timing. As a result, although the nozzle columns are shifted in the transport direction, the dot columns of the four colors YMCK along the sheet width direction can be formed at the same transport-direction position, so that it is possible to suppress deterioration in image quality.

In addition, by commonly using a driving signal COM to eject the liquids from the nozzle columns (for example, sub Y and main M) that eject different liquids and are aligned in the sheet width direction, it is possible to decrease the number of delay circuits and to reduce cost. In addition, it is possible to prevent the circuits from becoming complicated. If eight different driving signals COM are generated to individually eject liquids from eight nozzle columns of a head 31, eight delay circuits are needed, and cost is increased. In other words, by using a common driving signal COM to eject the liquids from the nozzle column that eject different liquids and are aligned in the sheet width direction, it is possible to reduce cost.

The entire disclosure of Japanese Patent Application No. 2008-201101, filed Aug. 4, 2008 is expressly incorporated by reference herein.

What is claimed is:

1. A liquid ejecting apparatus comprising a head including:
a first nozzle column where nozzles ejecting a first liquid are aligned in a predetermined direction at a predetermined interval;
a second nozzle column where nozzles ejecting the first liquid are aligned in the predetermined direction at the predetermined interval;
a third nozzle column where nozzles ejecting a second liquid are aligned in the predetermined direction at the predetermined interval; and
a fourth nozzle column where nozzles ejecting the second liquid are aligned in the predetermined direction at the predetermined interval,
wherein the first nozzle column is disposed off of the second nozzle column in a direction intersecting the predetermined direction, and the interval between a nozzle at an end portion of the first nozzle column and a nozzle at an end portion of the second nozzle column is the predetermined interval in the predetermined direction,
wherein the fourth nozzle column is disposed off of the third nozzle column in the direction intersecting the predetermined direction, and the interval between a nozzle at an end portion of the third nozzle column and a nozzle at an end portion of the fourth nozzle column is the predetermined interval in the predetermined direction,
wherein the second nozzle column and the third nozzle column are disposed to be aligned in the predetermined direction, and
wherein the liquids are ejected from the second nozzle column and the third nozzle column according to a common driving signal.

2. The liquid ejecting apparatus according to claim 1, wherein a first driving signal generating unit generates a driving signal that is used to eject the first liquid from the first nozzle column, a second driving signal generating unit generates the common driving signal, and a third driving signal generating unit generates a driving signal that is used to eject the second liquid from the fourth nozzle column.

3. The liquid ejecting apparatus according to claim 2,
wherein a number of nozzles of the second nozzle column is smaller than that of the first nozzle column, and
wherein a number of nozzles of the fourth nozzle column is smaller than that of the third nozzle column.

4. The liquid ejecting apparatus according to claim 3,
wherein a plurality of the heads are disposed to be aligned in the predetermined direction, and
wherein the second liquids are ejected from the fourth nozzle columns of the heads according to the driving signal generated by the third driving signal generating unit.

5. The liquid ejecting apparatus according to claim 2, wherein a generating timing of a driving pulse included in the driving signal generated by the first driving signal generating unit, a generating timing of a driving pulse included in the common driving signal generated by the second driving signal generating unit, and a generating timing of a driving pulse included in the driving signal generated by the third driving signal generating unit are adjusted.

6. The liquid ejecting apparatus according to claim 1, wherein the head includes: a first input unit to which a driving signal that is used to eject the first liquid from the nozzles of the first nozzle column is input: a second input unit to which the common driving signal is input: and a third input unit to which a driving signal that is used to eject the second liquid from the nozzles of the fourth nozzle column is input.

7. The liquid ejecting apparatus according to claim 1, wherein a first driving signal generating unit generates a driving signal that is used to eject the first liquid from the first nozzle column, a second driving signal generating unit generates the common driving signal, and a third driving signal generating unit generates a driving signal that is used to eject the second liquid from the fourth nozzle column,
wherein a number of nozzles of the second nozzle column is smaller than that of the first nozzle column, and
wherein a number of nozzles of the fourth nozzle column is smaller than that of the third nozzle column,
wherein a plurality of the heads are disposed to be aligned in the predetermined direction,
wherein the second liquids are ejected from the fourth nozzle columns of the heads according to the driving signal generated by the third driving signal generating unit,
wherein a generating timing of a driving pulse included in the driving signal generated by the first driving signal generating unit, a generating timing of a driving pulse included in the common driving signal generated by the second driving signal generating unit, and a generating timing of a driving pulse included in the driving signal generated by the third driving signal generating unit are adjusted, and
wherein the head includes: a first input unit to which the driving signal that is used to eject the first liquid from the nozzles of the first nozzle column is input: a second input unit to which the common driving signal is input: and a third input unit to which a driving signal that is used to eject the second liquid from the nozzles of the fourth nozzle column is input.
